(19) United States
(12) Patent Application Publication
(10) Pub. No.: US 2010/0101668 A1
(43) Pub. Date: Apr. 29, 2010

(54) Check Valve

(76) Inventor: Oene ROORDA, Bragg Creek (CA)

Correspondence Address: Lambert Intellectual Property Law, Suite 200, 10328 - 81 Avenue, Edmonton, AB, T6E 1X2, CA

(21) Appl. No.: 12/260,068

(22) Filed: Oct. 28, 2008

(51) Int. Cl. F16K 15/02

(52) U.S. Cl. 137/540

(57) ABSTRACT

A check valve is described using the venturi effect to enhance the force supplied by forward motion of fluid to fully open the valve, and a variable spring rate spring assembly to enable the valve to close the valve more quickly at the cessation of the forward motion of the fluid, while still allowing forward flow to fully open the valve.

### TECHNICAL FIELD

Check valves

### BACKGROUND

The prime function of a check valve is to protect mechanical equipment in a piping system by preventing reversal of flow by the fluid. A check valve allows a fluid to pass one way (“forward flow”), and blocks flow the other way (“reverse flow”). In order to avoid slam, it is desirable for the valve to close as quickly as possible as forward flow ends, ideally before reverse flow has started. When the valve is fully open, it is desired to have as little resistance to forward flow as possible. In order to meet these requirements, the general axial flow nozzle check valve design in which a spring pushes a disk onto a valve seat when there is no forward flow, and forward flow pushes the disk off the seat, is well known. Also well known is the use of an annular diffuser to recover pressure lost by the fluid as it travels around the edges of the disk.

The more force pushing the disk onto the valve seat, the faster it will close at the end of the forward flow, which is desirable. However, during the forward flow there must be enough force supplied by the fluid to fully open the valve against the spring force, or there will be excessive resistance to flow. A check valve using the venturi effect to counteract a spring force was disclosed in Griswold et al (U.S. Pat. No. 4,333,495) but Griswold used the venturi effect to enable a check valve to remain open at a lower pressure drop then required to initially open the valve, whereas the check valve disclosed in this document instead uses the venturi effect with a variable rate spring assembly to enable a more rapid closing of the valve at the cessation of forward flow.

### SUMMARY

In order to close the valve more quickly as forward flow ceases, this check valve design uses the venturi effect to lower the pressure behind the disk, causing an increase in the fluid forces acting to open the valve, and a spring assembly with a variable spring rate enabling a greater spring force for a part of the travel of the disk while still allowing the forward flow to completely open the valve. This variable spring rate more closely matches the profile of fluid forces on the disk during forward flow and thus enables the valve to close more quickly when forward motion of the fluid ceases, while still fully opening during forward flow.

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 is a side cutaway view of an embodiment of the check valve

FIG. 2 is sequence of side cutaway outline views showing the embodiment of FIG. 1 moving from closed to fully open position.

FIG. 3 is a perspective view of the embodiment of FIG. 1 showing the upstream end of the valve

FIG. 4 is a perspective view of the embodiment of FIG. 1 showing the downstream end of the valve.

FIG. 5 shows a graph of the spring forces and fluid forces on the disk vs. the position of the disk for a typical valve of the embodiment of FIG. 1.

### DETAILED DESCRIPTION

Immaterial modifications may be made to the embodiments described here without departing from what is covered by the claims.

In order to minimize slam, a check valve should close as quickly as possible when forward flow through the valve ceases. In order to minimize pressure losses, it should also open fully under normal forward flow conditions. In order to meet the requirement to close quickly, it is best to use springs as stiff as possible to close the valve, but if the springs used are too strong, the check valve will not fully open under normal forward flow. The check valve described here uses the venturi effect to enhance the force supplied by forward flow to open the check valve, thus enabling the use springs that would have prevented the valve from opening fully under normal forward flow in the absence of the venturi effect. The use of a spring assembly with a variable spring rate enables the spring forces to more closely match the fluid forces during forward flow throughout the range of travel of the disk, maximizing the speed at which the valve closes as forward flow through the valve ceases.

The check valve has a valve body defining a fluid passageway, with a valve seat in the fluid passageway. A valve disk support assembly is mounted within the fluid passageway, and a disk is connected to the disk support assembly, so as to be able to move in a range of travel extending from a closed position in which the disk touches the valve seat, to a fully open position. In principle the disk support assembly could be upstream or downstream of the disk, but if it is located downstream it can also act as a diffuser and as a bounding element. A spring assembly biases the disk towards the valve seat in the absence of forward flow of fluid through the valve. A bounding element is located at or downstream of the fully open position of the disk, so that there is a variable volume of fluid between the disk and the bounding element. The volume of fluid is connected, via the gap between the edge of the disk and the edge of the bounding element, to a narrow part of the fluid passageway so that forward flow will lead to a lower pressure in the volume of fluid due to the venturi effect. The gap between the disk and the bounding element may reduce to zero when the valve is fully open. The drop in pressure in the volume of fluid enhances the force on the disk pushing it towards the fully opened position during the forward flow. The configuration of the bounding element, valve disk and fluid passageway acting on forward flow through the valve produces a profile of fluid forces on the disk during forward flow throughout the range of travel of the disk.

In contrast to Griswold, who simply uses this effect to increase the ratio of the pressure differential needed to open the valve to the pressure drop while the valve is open, this check valve uses a spring assembly with a variable spring rate to supply additional spring force particularly for the part of the range of travel in which there is a significant venturi effect during forward flow, thus improving the ratio of the closing speed to the pressure drop while the valve is open, without necessarily affecting the pressure differential needed to initially open the valve. This additional spring force counterbalancing the force from the venturi effect can be provided by a second spring, or by a spring with a variable spring rate. The variable spring rate enables the force provided by the spring assembly to more closely match the profile of fluid forces on the disk, enabling the valve to close more quickly when forward flow ceases while still allowing forward flow to fully open the valve. The use of additional spring force countering the venturi effect may also help to prevent the disk from abruptly impacting the bounding element as it moves to the fully open position.

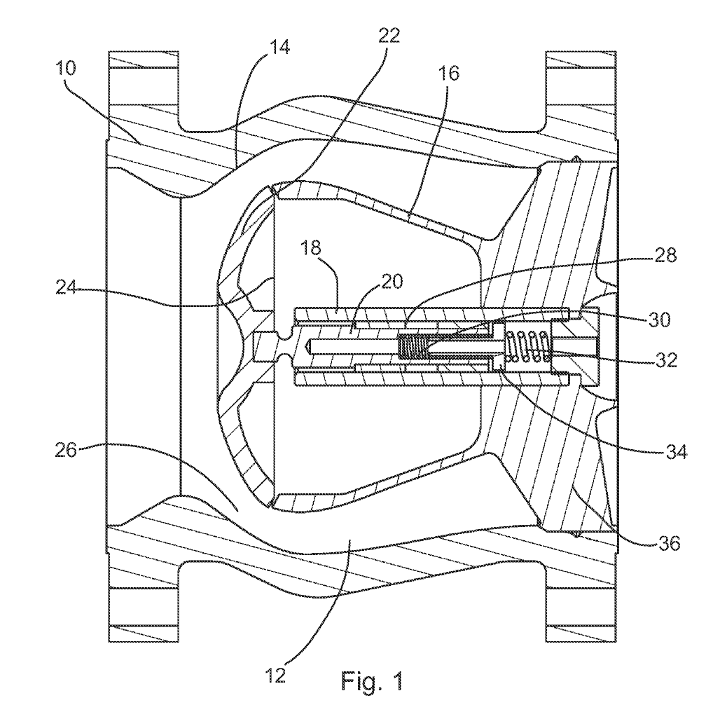

FIG. 1 shows the preferred embodiment in a fully open position. The valve body 10 defines a fluid passageway 12, with a valve seat 14 in the fluid passageway. Mounted within the valve body on fins 36 there is a valve disk support assembly 16 which also acts as a diffuser. Inside the valve disk support assembly there is a shaft guide 18 through which moves a shaft 20. A disk 22 is mounted on the end of the shaft, configured so that it can move between the valve seat and a bounding element 24 here defined by one end of the valve disk support assembly. When the valve is not fully open, there will be a volume of fluid (not shown) between the disk and the bounding element; the bounding element is located near a narrow part 26 of the fluid passageway so that forward flow of fluid through the valve will induce a low pressure in the volume of fluid by the venturi effect. A bearing or bearings 28 may be placed between the shaft and shaft guide to reduce friction. In this embodiment there are two springs, a primary spring 30 and a secondary spring 32 separated by a spring spacer 34. The springs, along with the spring spacer and shaft, comprise a spring assembly connecting the valve disk support assembly to the valve disk, and are configured so as to move the disk onto the valve seat, closing the valve, in the absence of forward flow of fluid through the valve; while allowing sufficiently strong forward flow of the fluid to supply a force, enhanced by the venturi effect, sufficient to move the disk to the bounding element, fully opening the valve. In this embodiment, as the disk moves from the valve seat to the fully opened position, the primary spring compresses first and the secondary spring begins compressing after the primary spring has finished compressing.

The secondary spring has a greater spring rate than the primary spring and is only engaged during a part of the range of travel in which, when there is forward flow, there is a significant force on the disk due to the low pressure on one side caused by the venturi effect. The spring force of the secondary spring is thus counterbalanced by the force on the disk from the venturi effect so that the secondary spring will not prevent the valve from becoming fully open, while still providing an additional spring force to ensure rapid closing of the valve when forward motion of the fluid ceases.

In another embodiment, a single variable spring rate spring could be used, the single spring providing an enhanced spring rate for a portion of the range of travel in which during forward motion of the fluid there is a significant force on the disk from the venturi effect, the additional force due to the change in spring rate serving the same purpose as the additional force from a secondary spring in the embodiment of FIG. 1. In the embodiment of FIG. 1, the valve disk rests against the bounding element when the valve is in the fully opened position.

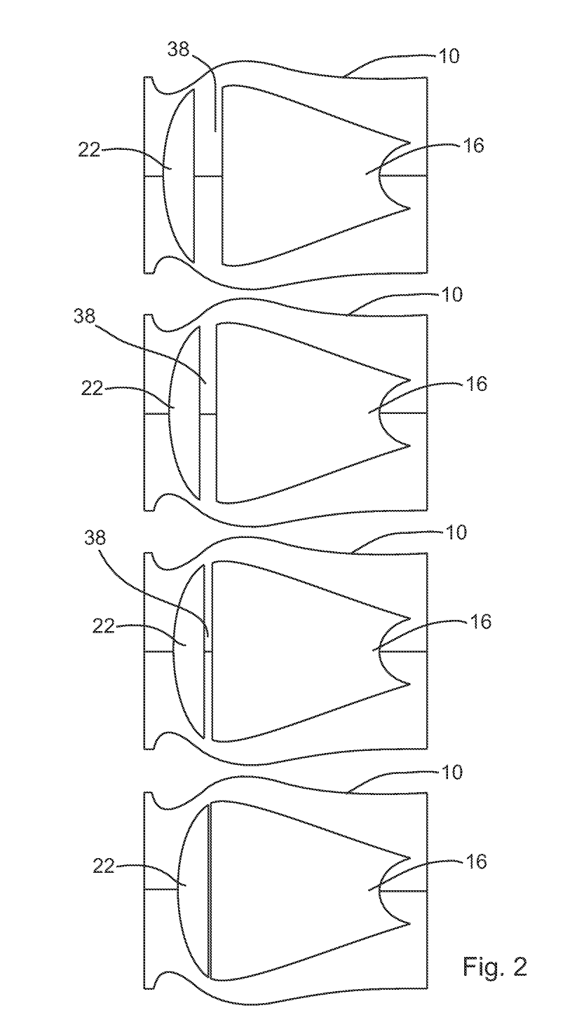

FIG. 2 shows the embodiment of FIG. 1, in a closed position (at top) and in progressively more open positions towards the bottom. While the valve is not fully open, there is a fluid volume 38 between the disk and the bounding element (which is in this embodiment the end of the disk support assembly facing the disk). Forward fluid motion results in a reduction of pressure in this volume due to the venturi effect.

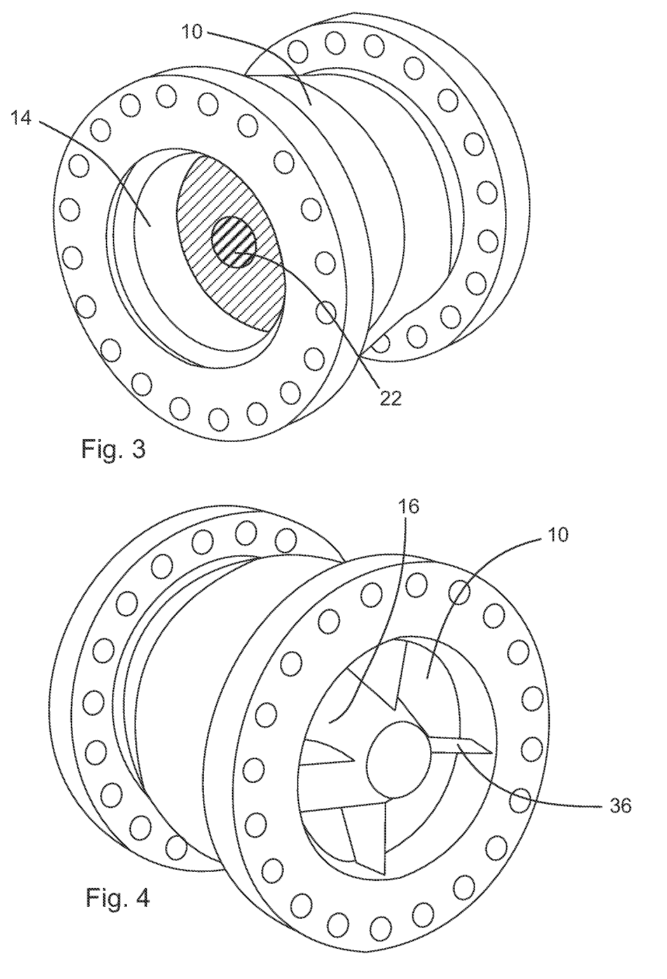

FIG. 3 shows the embodiment of FIG. 1 in a perspective view looking at the upstream end of the valve. The valve disk 22 and valve body 10 are visible in this view, as is the constriction in the valve body that acts as the valve seat 14.

FIG. 4 shows the embodiment of FIG. 1 in a perspective view looking at the downstream end of the valve. The valve body 10 and fins 36 are visible in this view, as is the downstream end of the valve disk support assembly 16.

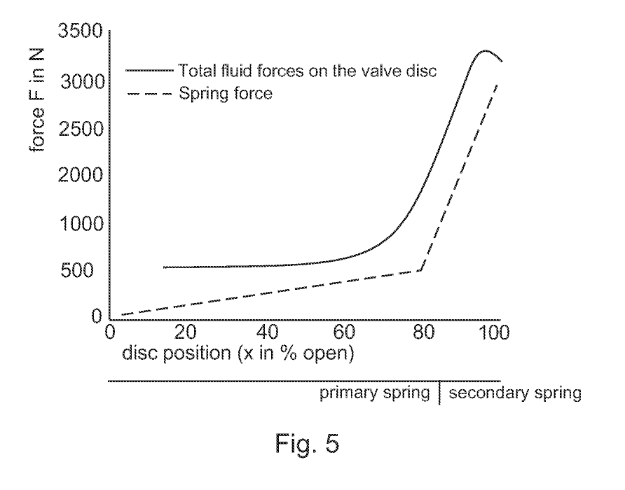

FIG. 5 shows a graph of the spring forces and fluid forces (the profile of fluid forces) on the valve disk vs. the position of the disk for a typical valve of the embodiment of FIG. 1 under conditions of forward flow of fluid through the valve. In order for the forward flow to be able to fully open the valve, the fluid forces must exceed the spring forces for the full range of motion of the disk. At the same time, a greater spring rate enables a faster closing of the disk. The force supplied by the disk near the fully opened position is particularly important, as the disk will begin closing once the fluid forces on the valve disk no longer exceed the spring forces. The increase of the spring rate near the fully opened position allows the force provided by the spring assembly to match the profile of fluid forces more closely than a spring assembly with a constant spring rate.

In the claims, the word “comprising” is used in its inclusive sense and does not exclude other elements being present. The indefinite article “a” before a claim feature does not exclude more than one of the feature being present. Each one of the individual features described here may be used in one or more embodiments and is not, by virtue only of being described here, to be construed as essential to all embodiments as defined by the claims.

What is claimed is:

1. A check valve, comprising:
a valve body defining a fluid passageway, with a valve seat in the fluid passageway;
a valve disk support assembly mounted within the valve body;
a valve disk having a range of travel from the valve seat to a position of maximum displacement from the valve seat;
a bounding element located downstream from the disk, the valve disk and the bounding element together defining a variable volume between the disk and the bounding element;
the bounding element, valve disk and fluid passageway having a configuration that produces a force profile on the valve disk during forward fluid flow through the valve body;
a spring assembly connected to the valve disk support assembly and connected to the valve disk; and
the spring assembly biasing the valve disk onto the valve seat in the absence of a forward flow of fluid through the valve, the spring assembly having a spring rate varying through the range of travel of the disk, the force provided by the spring assembly matching the force profile more closely than a spring assembly with a constant spring rate.

2. The check valve of claim 1, in which the bounding element is part of the valve disk support assembly.

3. The check valve of claim 1, in which the valve disk support assembly is also a diffuser.

4. The check valve of claim 1, in which during sufficiently strong forward flow the disk rests against the bounding element.

5. The check valve of claim 1, in which the spring assembly comprises two springs, at least one of the springs being engaged for only a part of the range of travel.

6. The check valve of claim 1, in which the spring assembly comprises a spring with a variable spring rate.

7. The check valve of claim 5 in which the spring assembly comprises a pair of coil springs.
